(19) United States
(12) Patent Application Publication
(10) Pub. No.: US 2012/0120001 A1
(43) Pub. Date: May 17, 2012

(54) CHARGE AMPLIFIER FOR MULTI-TOUCH CAPACITIVE TOUCH-SCREEN

(75) Inventors: Kusuma Adi NINGRAT, Singapore (SG); Giuseppe Noviello, Singapore (SG)

(73) Assignee: STMicroelectronics Asia Pacific Pte Ltd., Singapore (SG)

(21) Appl. No.: 12/948,203

(22) Filed: Nov. 17, 2010

(51) Int. Cl. G06F 3/041

(52) U.S. Cl. 345/173

(57) ABSTRACT

A circuit for measuring the cross-capacitance of a touch-screen sensor includes a charge amplifier having an input for coupling to the touch-screen sensor and an output for providing a voltage pulse, and a measurement delay chain having an input coupled to the output, and an output for providing a digitized output signal of the voltage pulse width, which is proportional to the value of the cross-capacitance.

### BACKGROUND OF THE INVENTION

1. Field of the Invention

The present invention relates to capacitive touch-screen systems and sensors. More particularly, the present invention relates to a circuit and method for measuring cross-capacitance in a touch-screen sensor.

2. Description of the Related Art

Capacitive touch-screen sensors are prone to noise, environmental variation, PCB variation and device lot variation. For a multi-touch touch-screen application, a force and sense sensing front-end is required. This front-end measures cross-capacitance in the X-axis and Y-axis of a projected capacitive touch-screen structure. A robust noise filtering technique is also required to reduce the effect of external noise which is easily coupled to the sensor. A calibration system which is able to offset the effect of environmental variation, PCB variation and device lot variation is also required.

Though circuits and methods are well known in the prior art of touch-screen sensors and systems for measuring cross-capacitance, they can suffer from certain drawbacks.

For example, in a first prior art technique, cross-coupling capacitance between X-lines and Y lines is measured using a front-end that measures the capacitance of a pad to ground by introducing a disturbance signal in a predetermined pattern. The capacitive front-end sensitivity is affected by the resistance of tracks connecting the sensor pad and the device. This is not suitable for bigger touch-screen applications since ITO (“Indium Tin Oxide”) has a significant resistance.

As another example, a second prior art cross-capacitance measurement technique uses X-lines as sensing lines and Y lines as disturbance lines. The cross capacitance value between a single X-line with all Y lines in each intersection can only be obtained after a whole sweep is completed. Hence, if the measurement is too slow, and the finger moves, the data acquired may not be accurate.

What is desired, therefore, is a circuit and robust method for measuring the cross-capacitance of a touch-screen sensor that overcomes the above and other limitations found in the prior art.

### SUMMARY OF THE INVENTION

A circuit for measuring the cross-capacitance of a touch-screen sensor includes a charge amplifier having an input for coupling to the touch-screen sensor and an output for providing a voltage pulse, and a measurement delay chain having an input coupled to the output, and an output for providing a digitized output signal of the voltage pulse width, which is substantially proportional to the value of the cross-capacitance. The corresponding method for measuring the cross-capacitance of a touch-screen sensor includes measuring charge associated with the cross-capacitance of the touch-screen sensor, converting the charge into a delay, and digitizing the delay to provide an output signal substantially proportional to the value of the cross-capacitance.

A preferred circuit embodiment for measuring the cross-capacitance of a touch-screen sensor includes a charge amplifier having an input coupled to a Y-line of the touch-screen sensor, and an output, a comparator having a first input coupled to the output of the charge amplifier, a second input for receiving a reference voltage, and an output, a delay circuit having an input coupled to the output of the comparator, and first and second outputs, and a measurement delay chain having first and second inputs respectively coupled to the first and second outputs of the delay circuit, and an output for providing a digitized output signal substantially proportional to the cross-capacitance of the touch-screen sensor.

### BRIEF DESCRIPTION OF THE DRAWINGS

Other objects and advantages of the present invention will become apparent from the following description of the preferred embodiment with reference to the drawings, in which:

FIG. 1 is a plan view of a capacitive touch-screen sensor pattern, highlighting an intersection between X-lines and Y lines that form a cross-capacitance desired to be measured;

FIG. 2 is a schematic diagram of a charge amplifier;

FIG. 3 is a block diagram of a cross-capacitance measurement circuit according to the present invention;

FIG. 4 is a timing diagram associated with certain nodes of the circuit of FIG. 3;

FIG. 5 is a more detailed circuit diagram associated with the measurement delay chain block shown in FIG. 3; and

FIG. 6 is a block diagram of a complete touch-screen sensor system according to the present invention.

### DETAILED DESCRIPTION

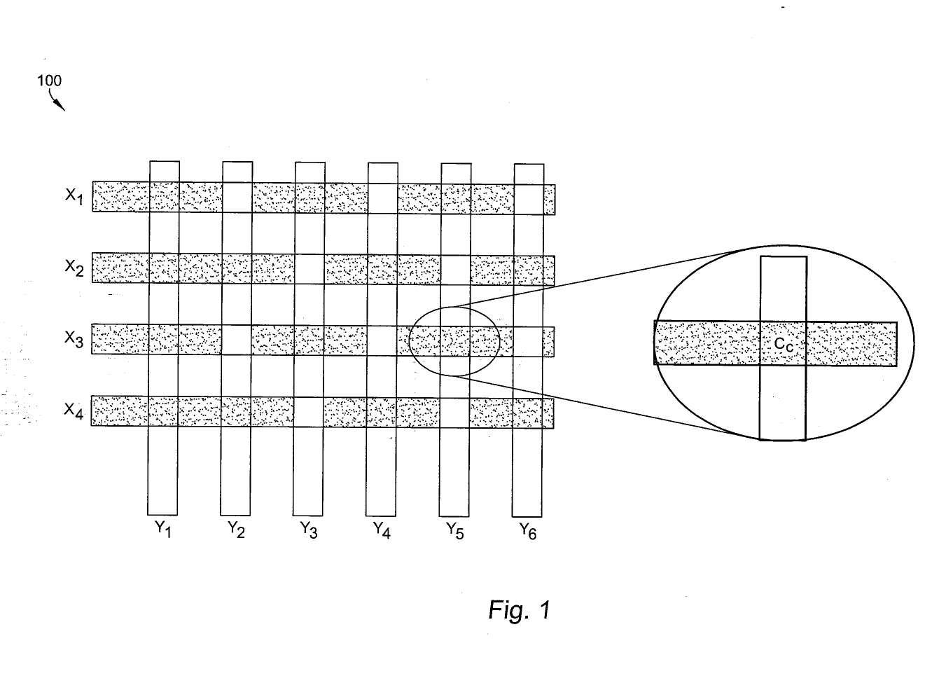

Referring now to FIG. 1, a capacitive touch-screen sensor pattern 100 is shown in plan view including a plurality of X-lines X₁, X₂, X₃, and X₄. While only four X-lines are shown, it will be apparent to those skilled in the art that any number of X-lines can be used. The touch-screen sensor pattern 100 shown in FIG. 1 also includes a plurality of Y lines Y₁, Y₂, Y₃, Y₄, Y₅, and Y₆. While only six Y lines are shown, it will be apparent to those skilled in the art that any number of Y lines can be used. Each of the intersections between an X-line and the Y lines form a cross-capacitance C_{C} as shown in FIG. 1. If a finger touches this intersection the total cross-capacitance will be reduced for a period of time.

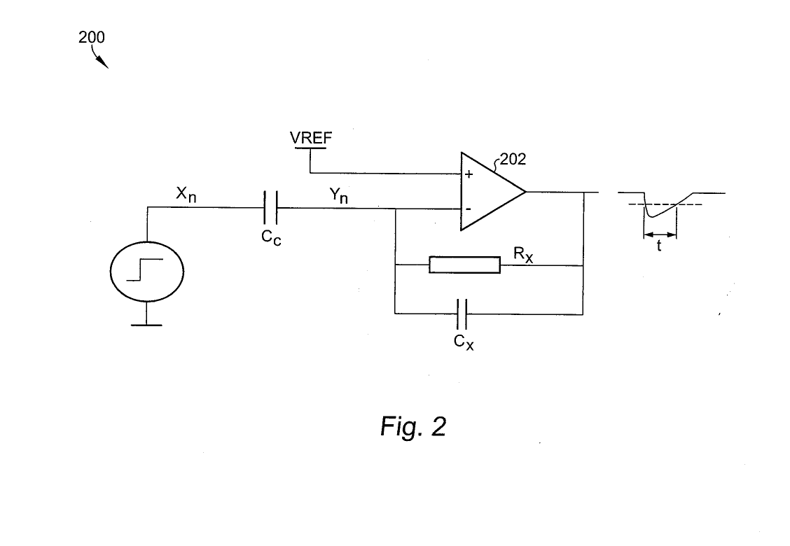

A schematic of a change amplifier 200 is shown in FIG. 2. The cross-capacitance C_{C} is shown as a capacitor between an X-line X_{N} and a Y line Y_{N}. The positive input of an operational amplifier 202 receives a reference voltage V_{REF}, and the negative input of the operational amplifier 202 is coupled to the Y line Y_{N}. A feedback network is coupled from the output of the operational amplifier to the negative input of the operational amplifier comprising a feedback resistor Rx and a feedback capacitor C_{X}. A rising edge signal is applied to the X_{N} line as shown. The charge on the cross-capacitance C_{C} is then transferred to the Y_{N} line. Charge amplifier 200 amplifies this charge and stores it across amplifier capacitance C_{X} and discharges the capacitor C_{X} slowly through feedback resistor Rx. The width (t) of the output voltage glitch or pulse at the output of the charge amplifier 200 is substantially proportional to the cross-capacitance C_{C}, with some degree of non-linearity, as shown.

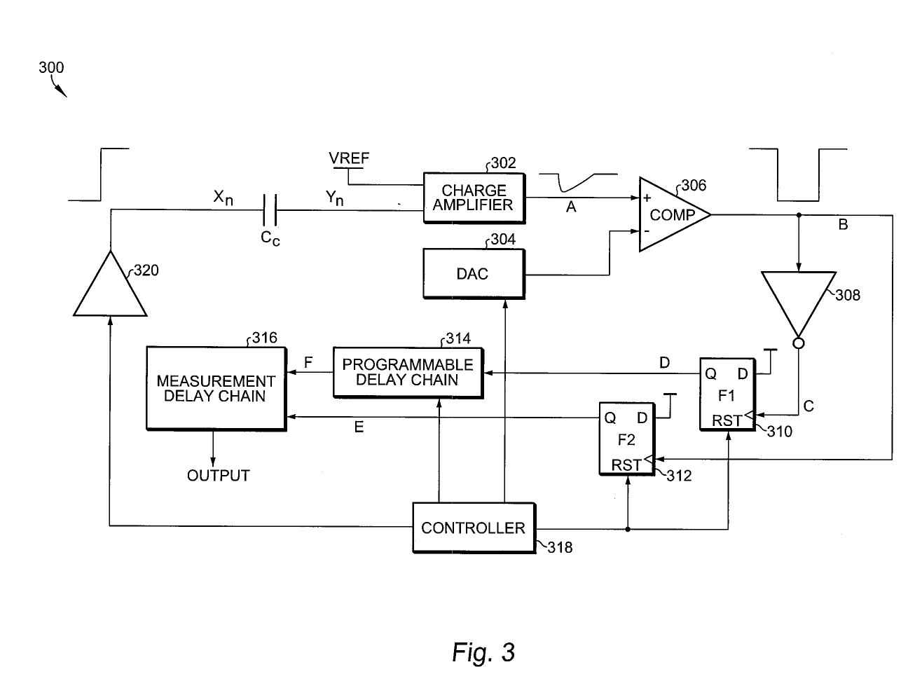

Referring now to FIG. 3, a circuit 300 for measuring the cross-capacitance C_{C} of a touch-screen sensor includes a charge amplifier 302 having an input coupled to a Y-line Y_{N} of the touch-screen sensor, and an output. A comparator 306 has a positive input coupled to the output of the charge amplifier 302 (node A), a second input for receiving a reference voltage, and an output at node B. A delay circuit includes inverter 308, D-type flips-flops 310 and 312, as well as programmable delay chain 314. The input of inverter 308 is coupled to the output of the comparator 306 at node B. The output of the inverter 308 is coupled to the clock input of the first flip-flop 310 at node C. The D input of flip-flop 310 is tied high. The Q output of the first flip-flop 310 is coupled to an input of the programmable delay chain 314 at node D. The output of the programmable delay chain 314 is tied to an input of the measurement delay chain 316 at node F. The output of comparator 306 is tied to the clock input of the second flip-flop 312, and the D input is tied high. The Q output of the second flip-flop 312 is coupled to an additional input of the measurement delay chain 316 at node E. The measurement delay chain has an output for providing a digitized output signal substantially proportional to the cross-capacitance of the touch-screen sensor. The charge amplifier 302 can be an operational amplifier having a feedback loop including a resistor and capacitor in parallel as previously discussed. The reference voltage for the comparator 306 is provided by a digital-to-analog converter 304. The measurement circuit 300 also includes a controller 318. The controller 318 is coupled to an X-line X_{N} of the touch-screen sensor through a buffer amplifier 320. The controller is also coupled to the programmable delay chain 314, the digital-to-analog converter 304, and to the reset inputs of flip-flops 310 and 312.

In operation, the controller 318 of the capacitance measurement circuit 300 initializes flip-flops 310 and 312. The controller 318 then sends a rising edge signal to Xn, cross-capacitance C_{C} will transfer the charge to the input of charge amplifier. The controller 318 then sets the output of the DAC 304 as the reference voltage of comparator 306. The output signal of the charge amplifier 306 is then fed to the positive input of comparator 306 at node A. The comparator output at node B provides an output pulse in response to the signal at the output of the charge amplifier 302 at node B. As previously described, the output of comparator 306 is directly coupled to the CLK input of flip-flop 312 and to the CLK input of flip-flop 310 through inverter 308. The Q outputs of flip-flops 310 and 312 are initially set to a logic zero. In response to an edge at the CLK input, the Q output will switch to a logic one. In circuit 300, the delay time of both flip-flops' rising edge is actually the width of the comparator pulse at node B. The controller 318 then sets the programmable delay chain 314 to delay the flip-flop output at node D so that the delay of flip-flops 310 and 312 output rising edge is in the measurement range of measurement delay chain 316. The measurement delay chain output is the digitized output of the comparator's pulse width, which is proportional to the value of cross-capacitance C_{C} with some degree of non-linearity.

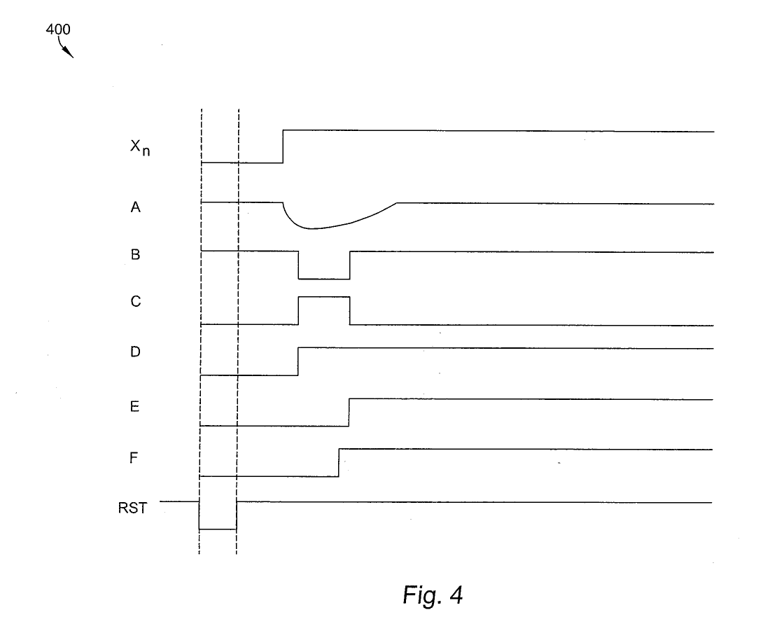

A timing diagram 400 is shown in FIG. 4, which shows the waveforms present on X-line X_{N}, nodes A, B, C, D, E, F, and the RST input of flip-flop 312.

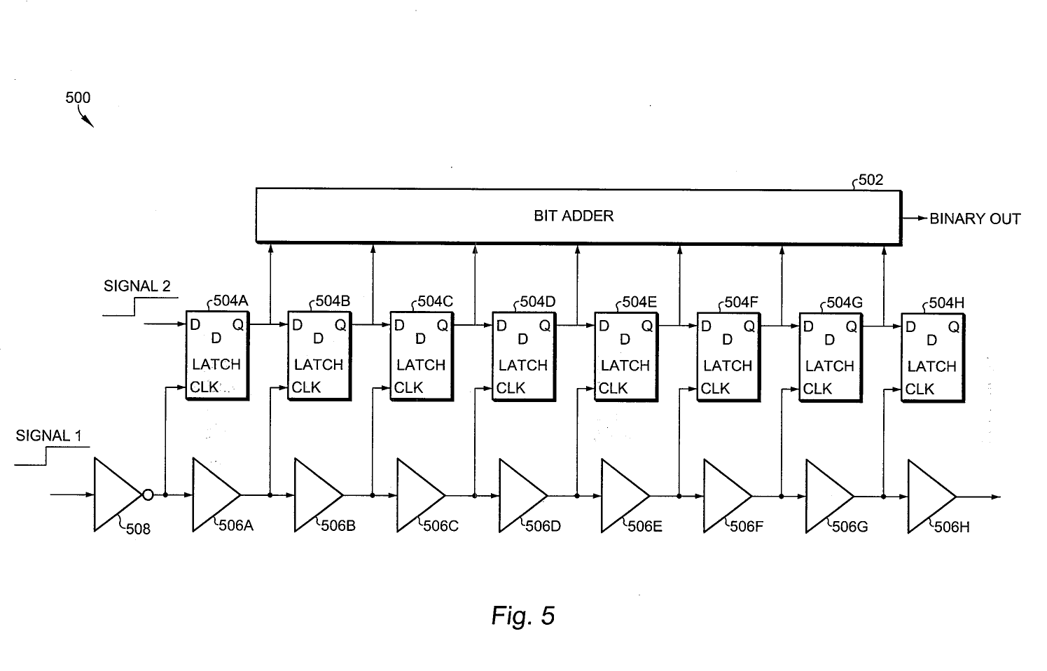

The measurement delay chain previously described is shown in further detail as circuit 500 shown in FIG. 5, including a buffer chain 506A-H coupled to the first input of the measurement delay chain, a flip-flop chain 504A-H coupled to the second input of the measurement delay chain, and a bit adder 502 coupled to the flip-flop chain and to the output of the measurement delay chain labeled Binary OUT. Circuit 500 also includes an inverter 508 coupled between the first input of the measurement delay chain and the buffer chain. A plurality of outputs of the buffer chain are coupled to a plurality of clock inputs of the flip-flop chain. As shown, the buffer chain comprises a plurality of serially-coupled buffer amplifiers 506A-H. The flip-flop chain comprises a plurality of serially-coupled D-type latches 504A-H. A plurality of Q outputs of the flip-flop chain are coupled to a plurality of inputs of the bit adder 502.

The resolution of the circuit 500 shown in FIG. 5 does not depend on the minimum delay of any component, rather it depends on the delay difference between the latches and the buffers. Node E or F is passed to the Signal 1 terminal and the other of nodes E or F is passed to the Signal 2 terminal. Binary OUT represents the delay between the Signal 2 and Signal 1 edges. The delay is represented as follows t=(M×(tPD-lat−tPD-buf))+tPD-inv. Where M is number of ones in the latches at the end of the cycle and tPD-lat is higher than tPD-buf is taken as an assumption. The propagation delay of the latches is tPD-latches, the propagation delay of the buffers is tPD-buf, and the propagation delay of the inverter is tPD-inv.

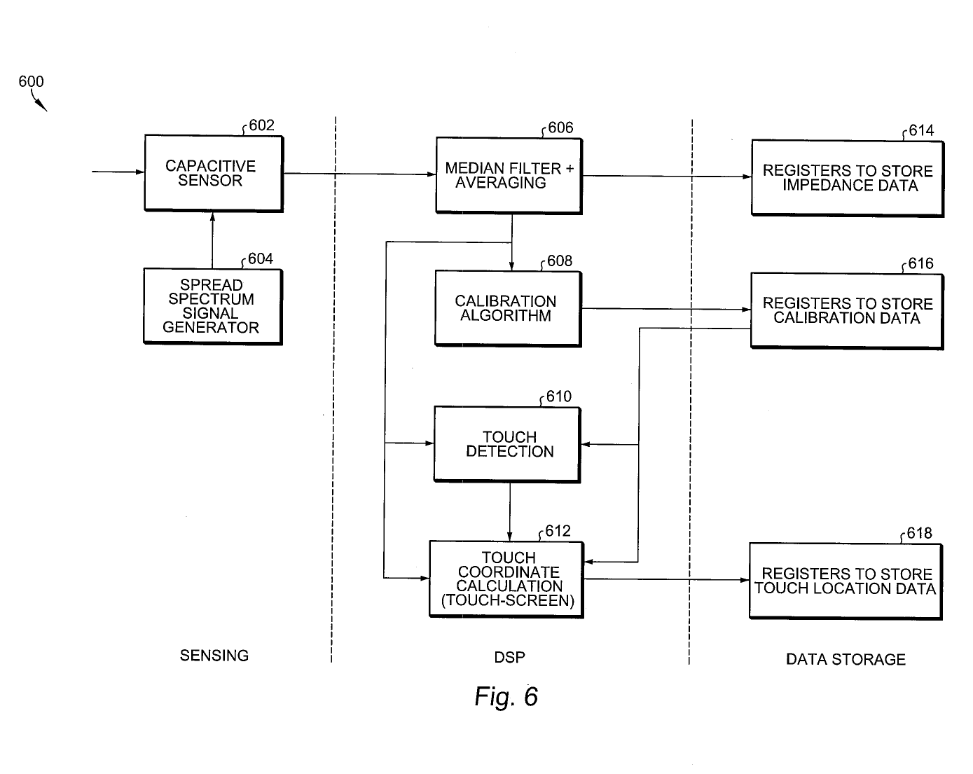

An entire touch-screen system 600 for use with the circuit of the present invention is shown in FIG. 6. The sensing portion of the touch-screen includes a capacitive sensor 602 and a spread spectrum signal generator 604. The DSP portion of the touch-screen system 600 includes a median filter and averaging block 606, a calibration algorithm block 608, a touch screen detection block 610, and a touch coordinate calculation block 612. A data storage portion of the touch-screen system 600 includes registers 614 to store impedance data, registers 616 to store calibration data, and registers 618 to store touch location data. The measurement circuit according to the present invention can be used with the touch-screen system 600.

In summary, a charge amplifier is used together with a measurement delay chain to measure the cross-capacitance of a touch-screen sensor by converting the charge transferred by the cross-capacitance into a delay and then digitizing the delay.

While only certain embodiments have been set forth according to the present invention, numerous other alternatives and modifications will be apparent from the above description to those skilled in the art. These and other alternatives are considered equivalents and within the spirit and scope of this disclosure and the appended claims.

We claim:

1. A circuit for measuring the cross-capacitance of a touch-screen sensor comprising:
a charge amplifier having an input for coupling to the touch-screen sensor and an output for providing a voltage pulse; and
a measurement delay chain having an input coupled to the output, and an output for providing a digitized output signal of the voltage pulse width, which is substantially proportional to the value of the cross-capacitance.

2. A method for measuring the cross-capacitance of a touch-screen sensor comprising:
measuring charge associated with the cross-capacitance of the touch-screen sensor;
converting the charge into a delay; and
digitizing the delay to provide an output signal substantially proportional to the value of the cross-capacitance.

3. A circuit for measuring the cross-capacitance of a touch-screen sensor comprising:
a charge amplifier having an input coupled to a Y-line of the touch-screen sensor, and an output;
a comparator having a first input coupled to the output of the charge amplifier, a second input for receiving a reference voltage, and an output;
a delay circuit having an input coupled to the output of the comparator, and first and second outputs; and
a measurement delay chain having first and second inputs respectively coupled to the first and second outputs of the delay circuit, and an output for providing a digitized output signal substantially proportional to the cross-capacitance of the touch-screen sensor.

4. The circuit of claim 3 wherein the charge amplifier comprises an operational amplifier.

5. The circuit of claim 4 wherein the operational amplifier further comprises a feedback loop including a resistor and capacitor in parallel.

6. The circuit of claim 3 wherein the reference voltage is provided by a digital-to-analog converter.

7. The circuit of claim 3 wherein the delay circuit comprises first and second flip-flops.

8. The circuit of claim 7 wherein the clock input of the first flip-flop is coupled to the output of the comparator through an inverter.

9. The circuit of claim 7 wherein the clock input of the second flip-flop is coupled to the output of the comparator.

10. The circuit of claim 3 wherein the delay circuit comprises a programmable delay chain.

11. The circuit of claim 3 further comprising a controller.

12. The circuit of claim 11 wherein the controller is coupled to an X-line of the touch-screen sensor through a buffer amplifier.

13. The circuit of claim 11 wherein the controller is coupled to the delay circuit.

14. The circuit of claim 11 wherein the controller is coupled to a digital-to-analog converter for providing the reference voltage.

15. The circuit of claim 3 wherein the measurement delay chain comprises:
a buffer chain coupled to the first input of the measurement delay chain;
a flip-flop chain coupled to the second input of the measurement delay chain; and
a bit adder coupled to the flip-flop chain and to the output of the measurement delay chain.

16. The circuit of claim 15 further comprising an inverter coupled between the first input of the measurement delay chain and the buffer chain.

17. The circuit of claim 15 wherein a plurality of outputs of the buffer chain are coupled to a plurality of clock inputs of the flip-flop chain.

18. The circuit of claim 15 wherein the buffer chain comprises a plurality of serially-coupled buffer amplifiers.

19. The circuit of claim 15 wherein the flip-flop chain comprises a plurality of serially-coupled D-type latches.

20. The circuit of claim 15 wherein a plurality of Q outputs of the flip-flop chain are coupled to a plurality of inputs of the bit adder.
